(19) United States
(12) Patent Application Publication
(10) Pub. No.: US 2019/0355341 A1
(43) Pub. Date: Nov. 21, 2019

(54) METHODS AND APPARATUS FOR PLAYBACK OF CAPTURED AMBIENT SOUNDS

(71) Applicant: Cirrus Logic International Semiconductor Ltd., Edinburgh (GB)

(72) Inventors: Brenton STEELE, Victoria (AU); Thomas HARVEY, Northcote (AU)

(73) Assignee: Cirrus Logic International Semiconductor Ltd., Edinburgh (GB)

(21) Appl. No.: 15/983,646

(22) Filed: May 18, 2018

(51) Int. Cl. G10K 11/178; G10L 25/90; G10L 25/93

(52) U.S. Cl. CPC G10K 11/17837; G10K 11/17827; G10L 25/90; G10K 2210/3046; G10L 25/93; G10K 2210/1081; G10K 11/17823

(57) ABSTRACT

An apparatus for playback of captured ambient sounds. The apparatus comprises a controller comprising a first input coupled to a respective first microphone for receiving an audio signal generated by the microphone, the audio signal representative of captured ambient sounds; a second input for receiving a playback instruction to instigate playback of ambient sounds; and an output coupled to a speaker. The apparatus further comprises data memory comprising a data structure for continuously buffering a most recent portion of the audio signal as an audio snippet. In response to detection of the playback instruction at the second input, the controller is configured to determine an output audio signal based on the audio snippet and provide the audio output signal to the output for substantially immediate playback through the speaker.

### TECHNICAL FIELD

The present disclosure relates to methods and apparatus for playback of captured ambient sounds, and in particular, for substantially immediate playback of captured ambient sounds.

### BACKGROUND

Headphones, and in particular headphone earbuds, are often paired with cellular phones, media players, and other electronic devices to allow users to enjoy listening to media while on the move. However, if an announcement/important external audio event is made (such as travel information at an airport or train station) while the user is listening to media (music/video), the media may mask the announcement, causing the user to have to stop/pause media playback, turn down the volume, remove their earbuds and/or engage listen-through mode. By the time the user takes any of these actions, a critical piece of the announcement may be lost.

### SUMMARY

According to a first aspect of the disclosure, there is provided an apparatus for playback of captured ambient sounds, the apparatus comprising:

a controller comprising:
a first input coupled to a respective first microphone for receiving an audio signal generated by the microphone, the audio signal representative of captured ambient sounds;
a second input for receiving a playback instruction to instigate playback of ambient sounds; and
an output coupled to a speaker;

data memory comprising a data structure for continuously buffering a most recent portion of the audio signal as an audio snippet;

wherein, in response to detection of the playback instruction at the second input, the controller is configured to determine an output audio signal based on the audio snippet and provide the audio output signal to the output for substantially immediate playback through the speaker.

The controller may be configured to compress one or more of (i) the received audio signal before storing the most recent portion as the audio snippet in the data structure and (ii) the audio snippet. The controller may be configured to process one or more of: (i) the received audio signal to enhance the sound quality of the audio signal before storing the most recent portion as the audio snippet in the data structure; and (ii) the audio snippet to enhance the sound quality of the output audio signal.

In some embodiments, the controller is configured to scan the received audio signal, identify segments of the received audio signal as speech and/or non-speech segments, and determine the audio snippet based on the scanning and identifying, wherein the audio snippet comprises the speech segments of the received audio signal only. In some embodiments, the controller is configured to scan the received audio signal, identify segments of the received audio signal as speech and/or non-speech segments, and determine the audio snippet based on the scanning and identifying such that the segments of speech and non-speech are associated with different playback rates. In some embodiments, the controller is configured to perform one or more of (i) playback at a higher rate; (ii) sample rate conversion with pitch preservation; and (iii) stretch and/or compress non-speech segments of the received audio signal to determine the audio snippet.

The output audio signal may comprise substantially an entirety of the audio snippet or a subsection of the audio snippet. The subsection may be a portion of the audio snippet that corresponds to a time period defined between a selectable playback start point and an end point of the audio snippet.

In some embodiments, the controller is configured to scan the audio snippet, identify segments of the audio snippet as speech and/or non-speech segments, and determine a processed audio snippet based on the scanning and identifying, wherein the processed audio snippet comprises the speech segments of the audio snippet only and the output audio signal is based on the processed audio snippet. In some embodiments, the controller is configured to scan the audio snippet, identify segments of the audio snippet as speech and/or non-speech segments, and determine a processed audio snippet based on the scanning and identifying such that the segments of speech and non-speech are associated with different playback rates. In some embodiments, the controller is configured to perform one or more of: (i) playback at a higher rate; (ii) sample rate conversion with pitch preservation; or (iii) stretch and/or compress non-speech segments of the audio snippet to determine the processed audio snippet.

The output audio signal comprises substantially an entirety of the processed audio snippet or a subsection of the processed audio snippet. The subsection may be a portion of the processed audio snippet that corresponds to a time period defined between a selectable playback start point and an end point of the audio snippet.

In some embodiments, the apparatus comprises a third input for receiving audio signals from an electronic device, wherein the controller is configured to selectively cause the audio signals to be provided to the output to allow media from the electronic device to be played through the speaker. In some embodiments, in response to detection of the playback instruction at the second input and in response to determining that media from the electronic device is being played through the speaker, the controller is configured to communicate with the electronic device to pause or stop the audio signal being transmitted to the third input.

In some embodiments, the apparatus comprises an activation mechanism coupled to the second input to allow a user to instigate playback of captured ambient sounds. The activation mechanism may comprise one or more of a playback speed option and a playback duration option.

In some embodiments, the apparatus comprises an adjusting means to allow for selective adjustment of a size of the data structure. For example, the data structure may comprise one of a First-In-First-Out (FIFO) queue or buffer, a circular buffer and a ping-pong buffer.

In some embodiments, the apparatus comprises a fourth input coupled to a respective further microphone for receiving a second audio signal generated by the further microphone, the second audio signal representative of captured ambient sounds; and wherein the controller is configured to perform multi-microphone noise cancellation based on the audio signal received at the first input and the second audio signal received at the fourth input and to determine a representative audio signal based on the audio signal and the second audio signal.

The apparatus may comprise the at least one microphone for capturing the ambient sounds and generating the audio signal for provision to the input. The apparatus may comprise the speaker for receiving the audio output signal from the output. The apparatus may comprise at least one headphone, wherein the headphone comprises the speaker.

According to another aspect of the disclosure, there is provided a method of playback of captured ambient sounds, the method comprising:

receiving, at a first input of a controller, an audio signal generated by a microphone, the audio signal representative of captured ambient sounds;

continuously buffering, by a data structure of data memory associated with the controller, a most recent portion of the audio signal as an audio snippet;

receiving, at a second input of the controller, a playback instruction to instigate playback of ambient sounds;

responsive to detecting the playback instruction at the second input, determining an output audio signal based on the audio snippet and providing the output audio signal to an output coupled to a speaker for substantially immediate playback through the speaker.

The method may comprise compressing one or more of (i) the received audio signal before storing the most recent portion as the audio snippet in the data structure and (ii) the audio snippet. The method may comprise processing one or more of: (i) the received audio signal to enhance the sound quality of the audio signal before storing the most recent portion as the audio snippet in the data structure; and (ii) the audio snippet to enhance the sound quality of the output audio signal.

In some embodiments, the method comprises scanning the received audio signal, identifying segments of the received audio signal as speech and/or non-speech segments, and determining the audio snippet based on the scanning and identifying, wherein the audio snippet comprises the speech segments of the received audio signal only. In some embodiments, the method comprises scanning the received audio signal, identifying segments of the received audio signal as speech and/or non-speech segments, and determining the audio snippet based on the scanning and identifying such that the segments of speech and non-speech are associated with different playback rates. In some embodiments, determining the audio snippet comprises performing one or more of: (i) playback at a higher rate; (ii) sample rate conversion with pitch preservation; or (iii) stretch and/or compress non-speech segments of the received audio signal.

The output audio signal may comprise substantially an entirety of the audio snippet or a subsection of the audio snippet. The subsection is a portion of the audio snippet that corresponds to the time period defined between a selectable playback start point and an end point of the audio snippet.

In some embodiments, the method comprises scanning the audio snippet, identifying segments of the saved audio snippet as speech and/or non-speech segments, and determining a processed audio snippet based on the scanning and identifying, wherein the processed audio snippet comprises the speech segments of the audio snippet only and the output audio signal is based on the processed audio snippet. In some embodiments, the method comprises scanning the audio snippet, identifying segments of the saved audio snippet as speech and/or non-speech segments, and determining a processed audio snippet based on the scanning and identifying such that the segments of speech and non-speech are associated with different playback rates. In some embodiments, determining the audio snippet comprises performing one or more of: (i) playback at a higher rate; (ii) sample rate conversion with pitch preservation; or (iii) stretch and/or compress non-speech segments of the audio snippet.

The output audio signal may comprise substantially an entirety of the processed audio snippet or a subsection of the processed audio snippet. The subsection may be a portion of the processed audio snippet that corresponds to a time period defined between a selectable playback start point and an end point of the audio snippet.

In some embodiments, the method comprises selectively causing audio signals received at a third input from an electronic device to be provided to the output to allow media from the electronic device to be played through the speaker.

In some embodiments, responsive to detecting the playback instruction at the second input and responsive to determining that media from the electronic device is being played through the speaker, communicating with the electronic device to pause or stop the audio signal being transmitted to the third input.

In some embodiments, the method comprises instigating playback of captured ambient sounds in response to activation of an activation mechanism coupled to the second input by a user. Instigating playback of captured ambient sounds may comprise instigating playback at a playback speed option and/or a playback duration option provided by a user.

In some embodiments, the method comprises selectively adjusting a size of the data structure in response to activation of an adjustment means. The data structure may comprise one of a First-In-First-Out (FIFO) queue or buffer, a circular buffer and a ping-pong buffer. In some embodiments, the method comprises receiving at a fourth input coupled to a respective further microphone a second audio signal generated by the further microphone, the second audio signal representative of capture ambient sounds; and performing multi-microphone noise cancellation based on the audio signal received at the first input and the second audio signal received at the fourth input.

According to another aspect of the disclosure, there provided an electronic device comprising the apparatus as described above. The electronic device may be: a mobile phone, for example a smartphone; a media playback device, for example an audio player; or a mobile computing platform, for example a laptop or tablet computer.

According to another aspect of the disclosure, there provided a computer-readable storage medium comprising instructions which, when executed by a computer, cause the computer to carry out the method of any one of the described embodiments.

Throughout this specification the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

### BRIEF DESCRIPTION OF DRAWINGS

By way of example only, embodiments are now described with reference to the accompanying drawings, in which:

FIG. 1 is a schematic illustration of an apparatus according to various embodiments of the present disclosure;

FIG. 2 is a process flow diagram of a method for continuously buffering a most recent portion of captured ambient sounds using the apparatus of FIG. 1; and

FIG. 3 is a process flow diagram of a method for playback of captured ambient sounds using the apparatus of FIG. 1, according to various embodiments.

### DESCRIPTION OF EMBODIMENTS

Embodiments of the present disclosure relate to methods and apparatus for playback of captured ambient sounds, and in particular, for substantially immediate playback of captured ambient sounds.

Ambient sounds captured from a user's external environment via microphones, (which may be arranged to be located on one or both ears) may be used to generate a representative audio signal. A data structure, such as a circular buffer or a ping-pong buffer, may be configured to continuously buffer a most recent portion of the audio signal as an audio snippet. On detection of a playback instruction to instigate playback of ambient sounds, for example, by the user, the captured audio (or a portion thereof) is played to the user via a headphone speaker. According, if the user misses announcement/important external audio event, for example, because it is masked by media being played through the user's headphones, the user may nonetheless instigate playback of the captured audio so that he/she can hear the announcement in its entirety and if desired, more than once.

In some embodiments, the user can select a point in time in the past from which to replay the captured audio (or a portion thereof). In some embodiments, the captured audio is processed before being played to the user, for example, to eliminate or speed up play of any non-speech segments of the captured audio. The captured audio may be processed to identify particular points of interest in the audio. The point in time in the past from which the captured audio is replayed may then be selected automatically depending on the identified points of interest. For example, points of interest may include segments of the audio in which human speech is first identified.

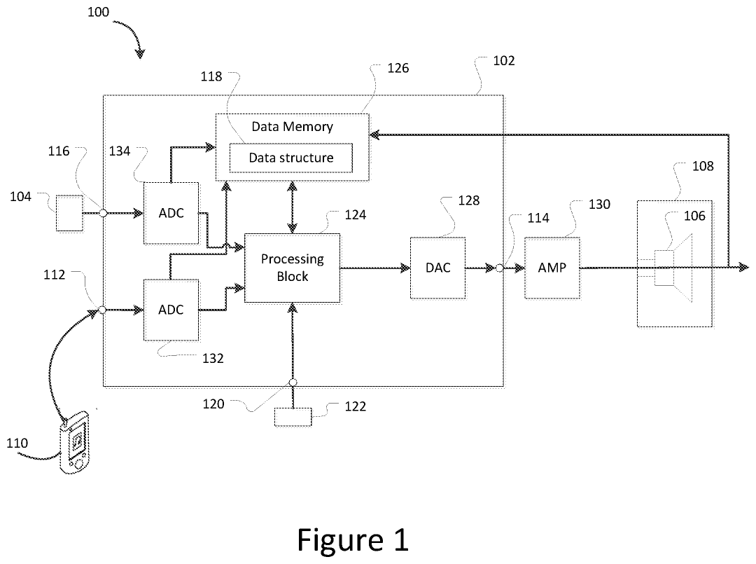

Referring to FIG. 1, there is illustrated an apparatus 100 for playback of captured ambient sounds. The apparatus 100 comprises a controller 102 for controlling functionality of the apparatus 100 including playback of captured audio signals. The controller 102 is coupled to one or more microphones 104 and is arranged to receive audio signals captured by the microphone 104. Although only one microphone 104 is depicted in FIG. 1, it will be appreciated that the controller 102 may be coupled to a plurality of microphones and may be arranged to receive audio signals captured by each of the microphones.

In some embodiments, the apparatus 100 further comprises an in-ear microphone (not shown) coupled to the controller 102 is coupled to the in-ear microphone (not shown). Information derived from audio signals captured by the in-ear microphone (not shown) may be used to better estimate ambient noise in an ear canal of a user and provide for improved ambient noise cancellation (ANC).

The controller 102 is also coupled to a speaker 106 for generating sound output and is arranged to control output provided to the speaker 106.

In some embodiments, the apparatus 100 comprises a headphone 108, such as a headphone earbud, and the speaker 106 is implemented within or integral with the headphone 108. It will be appreciated that the headphone 108 may comprise any suitable type of headphone, such as an around-ear or in-ear headphone. In some embodiments, the microphone 104 is disposed on or in the vicinity of the headphone 108.

In some embodiments, the controller 102 may be implemented in an audio integrated circuit, IC, (not shown). The audio IC (not shown) may be implemented within the headphone 108 and/or within an electronic device 110 coupled to the headphone 108. For example, the electronic device 110 may comprise a mobile phone, for example a smartphone; a media playback device, for example an audio player; or a mobile computing platform, for example a laptop or tablet computer. The electronic device 110 may be coupled to the headphone 108 wirelessly, for example, via Bluetooth (RTM) or similar wireless protocol or may be coupled to the headphone 108 using a wired connector such as a plug, jack or a USB.

As illustrated in FIG. 1, the controller 102 comprises a first input 112 for receiving audio signals from the electronic device 110. The controller 102 may be configured to selectively provide the audio signals (or a processed version of the audio signals) to an output 114 of the controller 102 coupled to the speaker 106 of the headphone 108 to allow media from the electronic device 110 to be played through the speaker 106.

The microphone 104 is configured to capture ambient sounds and to generate audio signals based on the capture ambient sounds (representative audio signals). The controller 102 comprises a second input 116 coupled to the microphone 104 for receiving the audio signals generated by the microphone 104. In embodiments where multiple microphones are provided, the controller 102 may comprise multiple inputs and ADCs, each coupled to a respective microphone for receiving audio signals generated by the microphone. The controller 102 may be further configured to determine a representative audio signal from the plurality of audio signals generated by the respective microphones 104.

The apparatus 100 comprises data memory 126, wherein data may be stored in a data structure 118. For example, data memory 126 may comprise static random access memory (SRAM) or flash memory. In some embodiments, the controller 102 comprises the data structure 118. In some embodiments, the data structure 118 may be implemented within an electronic device 110 coupled to the headphone 108, regardless of whether the controller 102 is implemented within the headphone 108 or within the electronic device 110. In other embodiments, the data structure 118 comprises a first data structure component (not shown) and a second data structure component (not shown), wherein the first data structure component (not shown) is implemented within the headphone 108 and the second data structure component (not shown) is implemented within the electronic device 110 coupled to the headphone 108.

The data structure 118 is configured to continuously buffer a most recent portion of the audio signal in the data structure 118 as an audio snippet. The data structure 118 may have a fixed size and accordingly, may be configured to accommodate a certain amount or fixed sized portion of the audio signal. Thus, as a most recent element of the audio signal is being buffered by the data structure 118, a least recent element of the audio signal in the data structure 118 may be being discarded or overwritten, for example, by the newly added most recent element. In some embodiments, the data structure 118 may be a data structure that uses a First-In-First-Out (FIFO) queue or a FIFO buffer of a particular size connected end-to-end to allow for continuous buffering of a data stream, such as a circular buffer. In some embodiments, the data structure 118 comprises a ping-pong buffer to allow for continuous buffering of a most recent portion of the audio signal. In some embodiments, the queue data structure comprises a FIFO stack of a particular size arranged to continuously discard an element at the top of the stack, shift the elements of the stack towards the top of the stack to allow a new element to be pushed onto the bottom of the stack. As the data structure 118 is configured to continuously buffer a most recent portion of the audio signal, the audio snippet represents the content of the data structure 118 at a particular point in time.

The apparatus 100 comprises an activation input 120 for receiving a signal indicative of activation of an activation mechanism 122 by a user selecting to instigate playback of a most recent portion of the audio portion (“listen-again mode”). For example, the activation mechanism 122 may be voice activated or physically activated and may be implemented within the electronic device 110, the speaker 106 and/or the microphone 104.

The apparatus 100 further comprises a processing block 124. In some embodiments, the controller 102 comprises the processing block 124. The processing block 124 comprises one or more processors (not shown) and instructions (executable code) which when executed by the one or more processors are configured to cause the controller 102 to control functionality of the apparatus 100 including playback of audio signals.

In response to detection of activation of the activation mechanism 122, the controller 102 is configured to provide an audio output signal based on the most recent portion of the audio signal in the data structure 118, i.e., the audio snippet, to the output 114 of the controller 102 for playback through the speaker 106. Upon activation of the activation mechanism 122, the audio output signal is provided to the output 114 within a relatively short period of time, for example, less than one second, and in some embodiments, playback may be substantially immediate or instantaneous.

In some embodiments, the controller 102 may be configured to control playback rates such that playback of the analog audio output signal is at a normal speech rate, an accelerated rate or a slower rate, as discussed in more detail below. In some embodiments, a user selectable option (not shown) may be provided to the user, for example, via the activation mechanism 122 or the electronic device 110, to allow the user to select the speed of playback and the controller 102 may be responsive to the user input to set or adjust the playback rate of the audio output signal.

In some embodiments, the processing block 124 may be configured to compress the most recent portion of the received audio signal before it is stored in the data structure 118 as an audio snippet and/or to compress/decompress the audio snippet retrieved from the data structure 118 before playback. For example, the processing block 124 may comprise a digital signal processor (DSP) configured to perform such compression. Compression techniques may include lossless compression such as FLAC, lossy compression techniques such as ADPCM or MP3, or speech detection based algorithms that only save the audio segments that contain speech. Applying compression will typically reduce the memory requirements for storing audio, and may result in a reduction in cost (due to a reduction in memory size of the data structure 118) or an increase in the length of audio that can be stored.

In some embodiments, the processing block 124 may be configured to process the most recent portion of the received audio signal before it is stored in the data structure 118 as an audio snippet and/or to process the audio snippet retrieved from the data structure 118 before playback to enhance the sound recording, for example, to remove any unwanted sounds, perform equalization, filtering, noise cancellation, etc.

If enhancement processing, such as multi-microphone noise cancellation, is performed before storing the received audio signal in the data structure 118, then only a single channel of (enhanced) audio needs to be stored, thereby requiring less memory. However, the ongoing processing power requirements of the controller 102 will be relatively higher as the enhancement algorithm will need to run continuously. On the other hand, if all of the microphone audio streams from the multiple microphones 104 need to be stored (requiring more memory) and the enhancement processing is performed after retrieving the audio snippet from the data structure 118, the ongoing processing power requirements of the controller 102 will be lower as the enhancement algorithm will only be performed on the audio snippet retrieved from the data structure 118in response to instigation of playback.

In some embodiments, the controller 102 is configured to replay the audio output signal at substantially the time the controller 102 detects the instigation instruction, for example, activation of the activation mechanism 122. In some embodiments, the controller 102 is configured to replay the entirety (or substantially all) of the audio snippet, i.e., the content of the data structure 118. In some embodiments, the controller 102 is configured to replay only a subsection of the audio snippet.

For example, the subsection may be a portion of the audio snippet that corresponds to a time period extending from a playback start point to an end of the audio snippet. The controller 102 may be configured to determine a select subsection of the audio snippet in the data structure 118 by identifying the playback start point from which to begin playback. The controller 102 may be configured to identify the playback start point as a fixed point in time in the past, for example, a predetermined time period, such as between 5 and 20 seconds in the past. In some embodiments, the apparatus 100 may comprise a user selectable option (not shown) for allowing user selection of a predetermined time period or a point in time at which to begin playback, for example, between 5 and 20 seconds in the past.

In some embodiments, the processing block 124 comprises a speech processing module (not shown). The speech processing module, when executed by the one or more processors (not shown) of the processing block 124 may be configured to cause the controller 102 to scan the audio signal (before it is stored in the data structure 118) and/or the audio snippet (after it is retrieved from the data structure 118) to detect speech. Speech detection can be achieved through a variety of means. For example, the processing block 124 may be configured to analyse the frequency response and modulation of the audio signal and/or audio snippet to detect the presence of speech. Accordingly, in some embodiments, the controller 102 may be configured to scan the audio snippet to detect speech and/or non-speech segments and to determine a subsection of the audio snippet as the audio output signal, wherein non-speech segments of the audio snippet have been removed and for example, the audio output signal comprises only the speech segments of the audio signal. In some embodiments, the controller 102 may be configured to scan the audio signal to detect speech and/or non-speech segments and to determine a subsection of the audio signal as the audio snippet, wherein non-speech segments of the audio signal have been removed and for example, the audio snippet comprises only the speech segments of the audio signal.

In some embodiments, the controller 102 may be configured to scan the audio signal (before it is stored in the data structure 118) and/or the audio snippet (after it is retrieved from the data structure 118) to detect speech and/or non-speech segments and to modify the audio signal and/or audio snippet so that periods of speech and non-speech are treated differently. For example, the controller 102 may be configured to detect speech and/or non-speech segments and to determine an audio snippet and/or audio output signal comprising varying playback rates. For example, the controller 102 may be configured to perform playback at a higher rate, perform sample rate conversion with pitch preservation and/or stretch/compress non-speech segments to determine an audio snippet and/or audio output signal comprising varying playback rates. In this way, playback of the audio output signal (which is derived from the audio snippet) may involve playback of the speech segments of the audio snippet at a normal speech speed and playback of gaps or non-speech segments of the audio snippet at an increased speed (relative to the normal speed).

In some embodiments, after playback of ambient sounds (“listen-again mode”) has been instigated, the apparatus 100 eventually reverts to real-time audio. By removing non-speech segments from the output audio signal or speeding up non-speech segments of the output audio signal, the controller 102 can replay the output audio signal faster than real-time, thereby allowing for a seamless transition back to live audio and avoiding a sudden jump, which may cause the loss of several seconds of audio. If the audio signal is processed in this way before storing the most recent portion of the audio signal in the data structure 118 as an audio snippet, the memory requirement for the data structure 118 may be reduced and/or more data may be stored in the data structure 118.

In some embodiments, the apparatus 100 may be configured to enhance audibility and/or intelligibility of the audio output signal. For example, the captured audio may not be loud enough to be clearly heard by the listener and may for example, be competing with ambient noise present in the ear canal or ambient noise and/or sound from the speaker 106 that was present at the time of recording and captured in the audio snippet.

In some embodiments, the controller 102 is configured to decrease such unwanted background noise by selectively increasing an amount of ambient noise cancellation (ANC).

In some embodiments, the controller 102 is configured to process the audio snippet or audio output signal to enhance the playback sound level or sound quality. For example, the controller 102 may be configured to increase the volume or change the frequency response so that the desired sound can be heard above the noise. In some embodiments, the controller 102 is configured to introduce a masking audio signal in order to reduce the distraction that the ambient noise may have on the user during the playback of the audio output signal.

Processing of the audio snippet or audio output signal may involve using audio signals received from one or more microphones and/or the speaker 106 to estimate the characteristic of the ambient noise and/or a desired signal present in the user's ear to determine how the characteristics of the masking sound is generated and/or the desired signal is enhanced. For example, the audio signals used to process the audio snippet or audio output signal to enhance the playback sound level or sound quality may be received from the speaker 106 and/or a noise reference mic.

The audio signals used may be processed before buffering the signals in data structure 118 or processed in real-time or continuously before buffering the processed signals in data structure 118. In some embodiments, the audio signals used may comprise a combination of both buffered audio signals (for example, audio snippets) and non-buffered audio signals (for example, audio signals received at the processing block without having been buffered in data structure 118).

In some embodiments, processing of the audio snippet may involve using an audio signal received from a second external microphone (not shown) and/or the output audio signal provided to the speaker 106 to detect and/or enhance desired sound sources and/or de-emphasis unwanted audio in the audio snippet and/or output audio signal. For example, in some embodiments, the controller 102 may be configured to perform echo reduction or cancellation, beamforming and/or spectral noise suppression techniques.

In some embodiments, if media is being played to the user at the time when the user instigates playback of the captured audio, the controller 102 may be configured to decouple the first input 112 and the output 114 and provide the audio output signal to the output 114 for playback to the user through the speaker 108. In some embodiments, the controller 102 may be configured to communicate with the electronic device 110 to pause or stop the audio signal being transmitted to and received at the first input 112.

The controller 102 may comprise a digital-to-analog converter (DAC) 128 to convert the audio output signal to an analog audio output signal for amplification by an amplifier 130 and output to the speaker 106.

In some embodiments, the controller 102 may comprise analog-to-digital converters (ADC) 132, 134 to convert analog signals received at the first and second inputs 112, 116 to digital signals for processing by the processing block 124. In some embodiments, the ADC 134 may be built into the microphone 104. In yet other embodiments, the microphone 104 may be a digital microphone and no ADC 134 may be required.

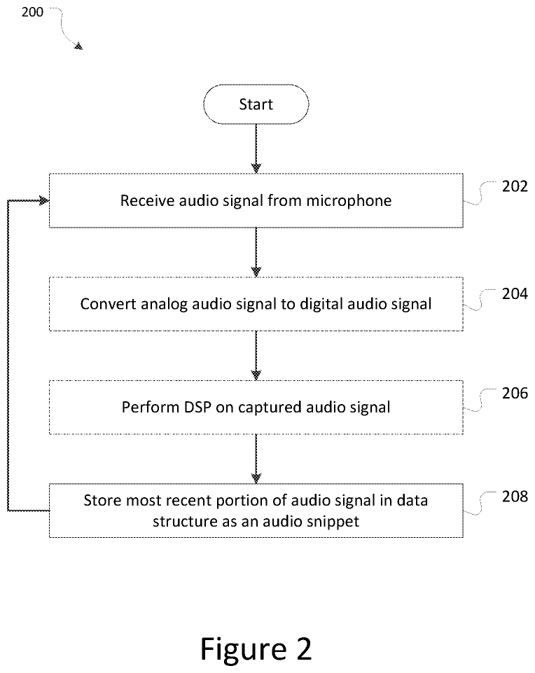

Referring now to FIG. 2, there is shown a process flow diagram of a method 200 for continuously buffering a most recent portion of captured audio, according to some embodiments. The method may be implemented by the controller 102 of the apparatus 100.

At 202, the controller 102 receives one or more audio signals generated by one or more microphones 104 of the apparatus 100. The audio signal(s) may be indicative or representative of ambient sounds, for example, in an environment surrounding the apparatus 100, and in some embodiments, surrounding the headphone 108. In embodiments where multiple audio input signals are received, the controller 102 may be configured to determine a representative audio signal from the plurality of audio signals as the audio signal.

In the event that the received audio signal is in analog format, at 204, the controller 102 optionally converts the analog audio signal to a digital audio signal.

In some embodiments, at 206, the controller 102 optionally performs digital signal processing on the digital audio signal. For example, the controller 102 may be configured to process, enhance and/or compress the digital audio signal, as described above.

At 208, the controller 206 continuously stores a most recent portion of the audio signal in a data structure 118 as an audio snippet. The controller 206 is configured to continuously buffer a most recent portion of the audio signal such that the content of the data structure 118 is continuously changing and the audio snippet is associated with a particular point in time. In some embodiments, as a most recent element of the audio signal is being added to the data structure 118, a least recent element of the audio signal or audio snippet is being discarded or overwritten by the most recent element in the data structure 118.

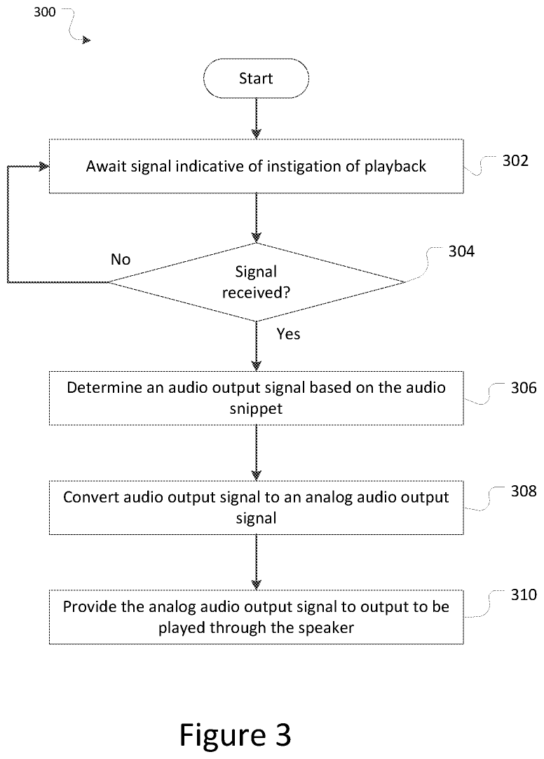

Referring now to FIG. 3, there is shown a process flow diagram of a method 300 for playback of captured ambient sounds, according to some embodiments. The method 300 may be implemented by the controller 102 of the apparatus 100.

The controller 102 awaits a signal indicative of a user instigating playback of ambient sounds (“listen-again mode”), for example, using activation mechanism 122, at 302.

In response to detection of the signal, at 304, the controller 102 determines an audio output signal based on the audio snippet retrieved from the data structure 118, at 306. In some embodiments, the audio output signal comprises the entire or substantially all of the audio snippet. In some embodiments, the audio output signal comprises a subsection of the audio snippet. For example, the controller 102 may be configured to determine a select subsection of the audio snippet in data memory 126, for example, by identifying a playback start point during the duration of the audio snippet from which to begin playback, and determining the audio output signal based on the subsection of the audio snippet. The playback start point may be a fixed point in the past, for example, between 5 and 20 seconds in the past and may be determined automatically by the controller 102 or may be user defined, for example, by means of a user input, such as activation mechanism 122.

The controller 102 may be configured to process the audio snippet or the subsection of the audio snippet to determine the audio output signal. In some embodiments, the audio output signal comprises only speech segments with any non-speech segments having been removed. For example, the controller 102 may determine the output audio signal by scanning the audio snippet or subsection of the audio snippet, identifying segments of the audio snippet or subsection as speech or non-speech segments, and determining the output audio signal, wherein the output audio signal comprises the speech segments of the audio snippet or subsection of the audio snippet only.

In some embodiments, the audio output signal comprises segments having varying playback rates. For example, the controller 102 may be configured to scan the audio snippet or subsection of the audio snippet to detect speech and/or non-speech segments and to modify the audio snippet or subsection such that the audio output signal comprises periods of speech associated with one playback rate and periods of non-speech associated with a different and faster playback rate.

At 308, the controller 102 converts the audio output signal from digital format to an analog audio output signal and at 312, the controller 102 provides the analog audio output signal to the output 214 to be played through the speaker 106.

The controller 102 may be implemented in firmware and/or software. If implemented in firmware and/or software, the functions described above may be stored as one or more instructions or code on a computer-readable medium. Examples include non-transitory computer-readable media encoded with a data structure and computer-readable media encoded with a computer program. Computer-readable media includes physical computer storage media. A storage medium may be any available medium that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to store desired program code in the form of instructions or data structures and that can be accessed by a computer. Disk and disc includes compact discs (CD), laser discs, optical discs, digital versatile discs (DVD), floppy disks and Blu-ray discs. Generally, disks reproduce data magnetically, and discs reproduce data optically. Combinations of the above should also be included within the scope of computer-readable media.

In addition to storage on computer readable medium, instructions and/or data may be provided as signals on transmission media included in a communication apparatus. For example, a communication apparatus may include a transceiver having signals indicative of instructions and data. The instructions and data are configured to cause one or more processors to implement the functions outlined in the claims.

It is noted that the term ‘module’ shall be used herein to refer to a functional unit or module which may be implemented at least partly by dedicated hardware components such as custom defined circuitry and/or at least partly be implemented by one or more software processors or appropriate code running on a suitable general purpose processor or the like. A module may itself comprise other modules or functional units.

It should be noted that the above-mentioned embodiments illustrate rather than limit the invention, and that those skilled in the art will be able to design many alternative embodiments without departing from the scope of the appended claims. The present embodiments are, therefore, to be considered in all respects as illustrative and not restrictive. The word “a” or “an” does not exclude a plurality, and a single feature or other unit may fulfil the functions of several units recited in the claims. Additionally the term “gain” does not exclude “attenuation” and vice-versa. Any reference numerals or labels in the claims shall not be construed so as to limit their scope.

1. An apparatus for playback of captured ambient sounds, the apparatus comprising:
a controller comprising:
a first input coupled to a respective first microphone for receiving an audio signal generated by the microphone, the audio signal representative of captured ambient sounds;
a second input for receiving an instruction to instigate playback of ambient sounds;
a third input for receiving a media audio signal from an electronic device; and
an output coupled to a speaker; and
data memory comprising a data structure for continuously buffering a most recent portion of the audio signal as an audio snippet;
wherein, the controller is configured to:
selectively cause the media audio signal to be provided to the output to allow media from the electronic device to be played through the speaker; and
in response to detection of the instruction at the second input:
determine an output audio signal based on the audio snippet;
in response to determining that media from the electronic device is being played through the speaker, stop the media from being played through the speaker; and
provide the output audio signal to the output for substantially immediate playback through the speakers;
wherein the controller is further configured to:
scan the received audio snippet;
identify segments of the audio snippet as speech or non-speech segments;
determine a processed audio snippet based on the scanning and identifying such that the segments of speech and non-speech are associated with different playback rates; and
determine the output audio signal based on the processed audio snippet.

2. The apparatus of claim 1, wherein the controller is configured to compress one or more of (i) the received audio signal before storing the most recent portion as the audio snippet in the data structure and (ii) the audio snippet.

3. The apparatus of claim 1, wherein the controller is configured to process the received audio signal to enhance the sound quality of the audio signal before storing the most recent portion as the audio snippet in the data structure.

4. (canceled)

5. (canceled)

6. The apparatus of claim 1, wherein the controller is configured to perform one or more of (i) playback at a higher rate; (ii) sample rate conversion with pitch preservation; and (iii) stretch and/or compress non-speech segments of the received audio signal to determine the audio snippet.

7. The apparatus of claim 1, wherein the output audio signal comprises substantially an entirety of the audio snippet.

8. The apparatus of claim 1, wherein the output audio signal comprises a subsection of the audio snippet.

9. The apparatus of claim 8, wherein the subsection is a portion of the audio snippet that corresponds to a time period defined between a selectable playback start point and an end point of the audio snippet.

10. (canceled)

11. (canceled)

12. The apparatus of claim 1, wherein the controller is configured to perform (i) playback at a higher rate; (ii) sample rate conversion with pitch preservation; or (iii) stretch and/or compress non-speech segments of the audio snippet; to determine the processed audio snippet.

13. The apparatus of claim 1, wherein the output audio signal comprises substantially an entirety of the processed audio snippet.

14. The apparatus of claim 1, wherein the output audio signal comprises a subsection of the processed audio snippet.

15. The apparatus of claim 14, wherein the subsection is a portion of the processed audio snippet that corresponds to a time period defined between a selectable playback start point and an end point of the audio snippet.

16. (canceled)

17. The apparatus of claim 1, wherein in response to detection of the instruction at the second input and in response to determining that media from the electronic device is being played through the speaker, the controller is configured to communicate with the electronic device to pause or stop the audio signal being transmitted to the third input.

18. The apparatus of claim 1, wherein the apparatus comprises an activator coupled to the second input to allow a user to instigate playback of captured ambient sounds.

19. The apparatus of claim 18, wherein the activator comprises one or more of a playback speed option and a playback duration option.

20. The apparatus of claim 1, further comprising an adjustor to allow for selective adjustment of a size of the data structure.

21. The apparatus of claim 1, wherein the data structure is one of a First-In-First-Out (FIFO) queue or buffer, a circular buffer and a ping-pong buffer.

22. The apparatus of claim 1, further comprising the at least one microphone for capturing the ambient sounds and generating the audio signal for provision to the input.

23. The apparatus of claim 1, further comprising a fourth input coupled to a respective further microphone for receiving a second audio signal generated by the further microphone, the second audio signal representative of captured ambient sounds; and wherein the controller is configured to perform multi-microphone noise cancellation based on the audio signal received at the first input and the second audio signal received at the fourth input and to determine a representative audio signal based on the audio signal and the second audio signal.

24. The apparatus of claim 1, further comprising the speaker for receiving the audio signal from the output.

25. The apparatus of claim 1, further comprising at least one headphone, wherein the headphone comprises the speaker.

26. An electronic device comprising an apparatus according to claim 1.

27. The electronic device of claim 26, wherein the electronic device is: a mobile phone, for example a smartphone; a media playback device, for example an audio player; or a mobile computing platform, for example a laptop or tablet computer.

28. A method of playback of captured ambient sounds, the method comprising:
receiving, at a first input of a controller, an audio signal generated by a microphone, the audio signal representative of captured ambient sounds;
continuously buffering, by a data structure of data memory associated with the controller, a most recent portion of the audio signal as an audio snippet;
receiving, at a second input of the controller, an instruction to instigate playback of ambient sounds;
selectively causing a media audio signal received at a third input from an electronic device to be provided to an output coupled to a speaker to allow media from the electronic device to the played through the speaker; and
responsive to detecting the playback instruction at the second input:
determining an output audio signal based on the audio snippet;
responsive to determining that media from the electronic device is being played through the speaker, stopping providing the media source to the output; and
providing the output audio signal to the output for substantially immediate playback through the speaker;
wherein the method further comprises:
scanning the audio snippet;
identifying segments of the saved audio snippet as speech and/or non-speech segments;
determining a processed audio snippet based on the scanning and identifying such that the segments of speech and non-speech are associated with different playback rates and
determining the output audio signal based on the processed audio snippet.

29. The method of claim 28, comprising compressing one or more of (i) the received audio signal before storing the most recent portion as the audio snippet in the data structure and (ii) the audio snippet.

30. The method of claim 28, comprising processing the received audio signal to enhance the sound quality of the audio signal before storing the most recent portion as the audio snippet in the data structure.

31. (canceled)

32. (canceled)

33. The method of claim 28, wherein determining the audio snippet comprises performing one or more of: (i) playback at a higher rate; (ii) sample rate conversion with pitch preservation; and (iii) stretch and/or compress non-speech segments of the received audio signal.

34. The method of claim 28, wherein the output audio signal comprises substantially an entirety of the audio snippet.

35. The method of claim 28, wherein the output audio signal comprises a subsection of the audio snippet.

36. The method of claim 35, wherein the subsection is a portion of the audio snippet that corresponds to the time period defined between a selectable playback start point and an end point of the audio snippet.

37. (canceled)

38. (canceled)

39. The method of claim 28, wherein determining the audio snippet comprises performing one or more of (i) playback at a higher rate; (ii) sample rate conversion with pitch preservation; and (iii) stretch and/or compress non-speech segments of the audio snippet.

40. The method of claim 28, wherein the output audio signal comprises substantially an entirety of the processed audio snippet.

41. The method of claim 28, wherein the output audio signal comprises a subsection of the processed audio snippet.

42. The method of claim 41, wherein the subsection is a portion of the processed audio snippet that corresponds to a time period defined between a selectable playback start point and an end point of the audio snippet.

43. (canceled)

44. The method of claim 28, wherein responsive to detecting the instruction at the second input and responsive to determining that media from the electronic device is being played through the speaker, communicating with the electronic device to pause or stop the audio signal being transmitted to the third input.

45. The method of claim 28, comprising instigating playback of captured ambient sounds in response to activation of an activator coupled to the second input by a user.

46. The method of claim 45, wherein instigating playback of captured ambient sounds comprises instigating playback at a playback speed option and/or a playback duration option provided by a user.

47. The method of claim 28, comprising selectively adjusting a size of the data structure in response to activation of an adjustment means.

48. The method of claim 28, wherein the data structure is one of a First-In-First-Out (FIFO) queue or buffer, a circular buffer and a ping-pong buffer.

49. The method of claim 28, comprising receiving at a fourth input coupled to a respective further microphone a second audio signal generated by the further microphone, the second audio signal representative of capture ambient sounds; and performing multi-microphone noise cancellation based on the audio signal received at the first input and the second audio signal received at the fourth input.

50. A non-transitory computer-readable medium comprising instructions which, when executed by a computer, cause the computer to carry out the method of claim 28.

51. An apparatus for playback of captured ambient sounds, the apparatus comprising:
a controller comprising:
a first input coupled to a respective first microphone for receiving an audio signal generated by the microphone, the audio signal representative of captured ambient sounds;
a second input for receiving an instruction to instigate playback of ambient sounds;
a third input for receiving a media audio signal from an electronic device; and
an output coupled to a speaker; and
data memory comprising a data structure for continuously buffering a most recent portion of the audio signal as an audio snippet;
wherein, the controller is configured to:
selectively cause the media audio signal to be provided to the output to allow media from the electronic device to be played through the speaker; and
in response to detection of the instruction at the second input:
determine an output audio signal based on the audio snippet;
in response to determining that media from the electronic device is being played through the speaker, stop the media from being played through the speaker; and
provide the audio signal to the output for substantially immediate playback through the speaker;
wherein the controller is further configured to:
scan the received audio signal;
identify segments of the received audio signal as speech and/or non-speech segments; and
determine the audio snippet based on the scanning and identifying such that the segments of speech and non-speech are associated with different playback rates.

52. A method of playback of captured ambient sounds, the method comprising:
receiving, at a first input of a controller, an audio signal generated by a microphone, the audio signal representative of captured ambient sounds;
continuously buffering, by a data structure of data memory associated with the controller, a most recent portion of the audio signal as an audio snippet;
receiving, at a second input of the controller, an instruction to instigate playback of ambient sounds;
selectively causing a media audio signal received at a third input from an electronic device to be provided to an output coupled to a speaker to allow media from the electronic device to be played through the speaker;
responsive to detecting the playback instruction at the second input:
determining an output audio signal based on the audio snippet;
responsive to determining that media from the electronic device is being played through the speaker, stopping providing the media source to the output; and
providing the output audio signal to the output for substantially immediate playback through the speaker;
wherein the method further comprises:
scanning the received audio signal;
identifying segments of the received audio signal as speech and/or non-speech segments; and
determining the audio snippet based on the scanning and identifying such that the segments of speech and non-speech are associated with different playback rates.

53. A non-transitory computer-readable medium comprising instructions which, when executed by a computer, cause the computer to carry out the method of claim 52.
